(19) United States
(12) Patent Application Publication
(10) Pub. No.: US 2022/0159643 A1
(43) Pub. Date: May 19, 2022

(54) APPARATUS AND METHOD OF CONTROLLING SIDELINK COMMUNICATION OF SAME

(71) Applicant: GUANGDONG OPPO MOBILE TELECOMMUNICATIONS CORP., LTD., Dongguan (CN)

(72) Inventor: Huei-Ming LIN, Victoria (AU)

(73) Assignee: GUANGDONG OPPO MOBILE TELECOMMUNICATIONS CORP., LTD., Dongguan (CN)

(21) Appl. No.: 17/666,329

(22) Filed: Feb. 7, 2022

Related U.S. Application Data
(63) Continuation of application No. PCT/CN2020/108909, filed on Aug. 13, 2020.
(60) Provisional application No. 62/887,267, filed on Aug. 15, 2019.

(51) Int. Cl. H04W 72/04

(52) U.S. Cl. CPC H04W 72/0406

(57) ABSTRACT

An apparatus and a method of controlling sidelink communication of the same are provided. A method of controlling sidelink communication of a base station includes using a downlink control information (DCI) format structure to provide at least one sidelink scheduling comprising at least one new radio (NR) scheduling function and providing, to one or more user equipments (UEs), at least one sidelink scheduling according to the DCI format structure. This can save UE processing complexity, power consumption, and control signalling overhead in a new radio (NR) downlink.

### CROSS REFERENCE TO RELATED APPLICATIONS

The disclosure is a continuation of an International Application No. PCT/CN2020/108909, filed on Aug. 13, 2020, titled “APPARATUS AND METHOD OF CONTROLLING SIDELINK COMMUNICATION OF SAME”, which is incorporated by reference in the present application in its entirety.

### BACKGROUND OF DISCLOSURE

### 1. Field of Disclosure

The present disclosure relates to the field of communication systems, and more particularly, to an apparatus and a method of controlling sidelink communication of the same, which can provide a good communication performance and high reliability.

### 2. Description of Related Art

For the advancement of sidelink communication technology developed under a 3rd generation partnership project (3GPP) to support ever-evolving vehicle-to-everything (V2X) use cases as part of global intelligent transportation system (ITS), it has progressed from an initial 4th generation—long term evolution (4G-LTE) based system to the latest 5th generation—ew radio (5G-NR) based system. As such, an advanced user equipment (UE) that is required to support all latest V2X use cases and services would need to operate both LTE-V2X and NR-V2X sidelink communications simultaneously within the same terminal. In order to avoid mandating all advanced UE to be equipped with extra transmit (Tx) and receive (Rx) antennas to save cost and to be always connected with LTE base station (eNB) and NR base station (gNB) to receive network instructions and scheduling for both radio access technologies (RATs) as LTE and NR coverage cannot guarantee to be everywhere, it is necessary to develop mechanism(s) for cross-RAT control of sidelink operations. That is, when an advanced UE that supports both LTE- and NR-based sidelink communications and connects to a 5G-NR gNB, the UE should be able to receive network configurations and control over the NR downlink (DL) for the scheduling of NR and LTE sidelink resources for transmission.

Currently for NR sidelink (SL) transmission under the network gNB control and scheduling, there are two modes of operation. Specifically, one of them is NR SL dynamic scheduling where the gNB provides only sufficient SL resources each time using a downlink control information (DCI) for UE transmission of one packet transport block (TB). The other NR SL mode of operation is NR SL semi-static scheduling by network gNB activating a configured NR SL Type2 configured grant (CG) for UE transmission of more than one packet TBs. The network gNB deactivates a NR SL Type2 CG (also often referred as release of CG resources) and activates another for switching services or when UE traffic pattern has changed. For this mode of NR SL operation, the activation/deactivation command is also provided via a DCI from the network gNB. Similarly, for the cross-RAT control of LTE sidelink operation, the network gNB provides configuration of LTE semi-persistent scheduling (SPS) processes of SL resources to the UE and activates/deactivates one of the configured SPS processes also using a DCI for LTE SL transmission. As can be seen, for the control and scheduling of NR multi-modes of SL operation and cross-RAT control of LTE SPS processes, everything is done via NR downlink DCI. Although the scheduling of SL operation via NR DCI can be quick, flexible and reasonably reliable (less than 1% error rate), but from the perspective of increasing number of sidelink operating scenarios and users, the amount of DL control signalling (signalling overhead for the system) also necessarily needs to be increased in order to function properly. With also increasing number of use cases per UE, the control signalling may go into an overloading mode and causing a capacity issue.

Furthermore, in order to schedule in different modes of NR sidelink operation and also be able to provide cross-RAT scheduling of LTE sidelink from a network gNB, different DCI control parameters would be necessary. If each of these scheduling controls is done using a specific DCI, there would be at least 3 different DCI formats, all with a different payload size. In terms of monitoring and blind detecting of NR DCIs, UE processing complexity, and power consumption for blind decoding of LTE and NR sidelink scheduling DCIs in NR downlink at the same time would be quite significant. If a UE is further involved in a NR SL groupcast or unicast session, which may require UE monitoring another DCI format, more UE processing and power consumption will occur.

Therefore, there is a need for an apparatus and a method of controlling sidelink communication of the same, which can save UE processing complexity, power consumption, and control signalling overhead in a new radio (NR) downlink.

### SUMMARY

An object of the present disclosure is to propose an apparatus and a method of controlling sidelink communication of the same, which can save UE processing complexity, power consumption, and control signalling overhead in a new radio (NR) downlink.

In a first aspect of the present disclosure, a base station of controlling sidelink communication includes a memory, a transceiver, and a processor coupled to the memory and the transceiver. The processor is configured to use a downlink control information (DCI) format structure to provide at least one sidelink scheduling comprising at least one new radio (NR) scheduling function. The transceiver is configured to provide, to one or more user equipments (UEs), at least one sidelink scheduling according to the DCI format structure.

In a second aspect of the present disclosure, a method of controlling sidelink communication of a base station includes using a downlink control information (DCI) format structure to provide at least one sidelink scheduling comprising at least one new radio (NR) scheduling function and providing, to one or more user equipments (UEs), at least one sidelink scheduling according to the DCI format structure.

In a third aspect of the present disclosure, a user equipment (UE) of controlling sidelink communication includes a memory, a transceiver, and a processor coupled to the memory and the transceiver. The transceiver is configured to receive, from a base station, at least one sidelink scheduling according to a downlink control information (DCI) format structure comprising at least one new radio (NR) scheduling function. The processor is configured to decode the at least one sidelink scheduling of the DCI format structure.

In a fourth aspect of the present disclosure, a method of controlling sidelink communication of a user equipment (UE) includes receiving, from a base station, at least one sidelink scheduling according to a downlink control information (DCI) format structure comprising at least one new radio (NR) scheduling function and decoding the at least one sidelink scheduling of the DCI format structure.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth of the present disclosure, a computer program causes a computer to execute the above method.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments (UEs) and a base station of controlling sidelink communication in a communication network system according to an embodiment of the present disclosure.

FIG. 2 is a flowchart illustrating a method of controlling sidelink communication of a base station according to an embodiment of the present disclosure.

FIG. 3 is a flowchart illustrating a method of controlling sidelink communication of a user equipment according to an embodiment of the present disclosure.

FIG. 4 is an exemplary illustration of a downlink control information (DCI) format structure according to an embodiment of the present disclosure.

FIG. 5 is an exemplary illustration of a downlink control information (DCI) format structure according to an embodiment of the present disclosure.

FIG. 6 is an exemplary illustration of a downlink control information (DCI) format structure according to an embodiment of the present disclosure.

FIG. 7 is an exemplary illustration of a downlink control information (DCI) format structure according to an embodiment of the present disclosure.

FIG. 8 is an exemplary illustration of usage of a downlink control information (DCI) format structure for sidelink broadcast, unicast, and groupcast communications according to an embodiment of the present disclosure.

FIG. 9 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In some embodiments of the present disclosure, an apparatus and a method of controlling sidelink communication of the same are provided to save UE processing complexity, power consumption, and control signalling overhead in a new radio (NR) downlink. In some embodiments, managing and controlling of multi-radio access technology (RAT) sidelink communications use a single common downlink control information (DCI) design and the use of network configured radio network temporary identifiers (RNTIs), it aims to resolve the prior art's deficiency of overloading of DCI signalling overhead on a NR Uu interface, increasing UE processing complexity, and battery power consumption issues. At the same time, the proposed method and apparatus additionally offer the following benefits for NR sidelink unicast and groupcast communications.

Sidelink scheduling information is shared between the UEs within a same group, allowing UEs to temporary shutdown/turn-off its RF and/or baseband reception mode/function to reduce power consumption and save battery.

Allowing a group header UE to forward/relay scheduling information to other group member UEs and thus supporting a groupcast operation scenario where not all UEs are within network coverage but still be able to be managed and scheduled by a network base station.

To further reduce the control signalling overhead, multiple NR SL Type2 CGs can be activated and/or deactivated at the same time within a DCI. This in turn allows UE to switch faster between SL Type2 CG resources to minimize interruption time for changing between services and traffic patterns, and early release of resources for other UEs.

Potentially one common DCI format can be used for scheduling all NR broadcast, groupcast and unicast sidelink communications, as well as activating/deactivating (release) of LTE SPS processes.

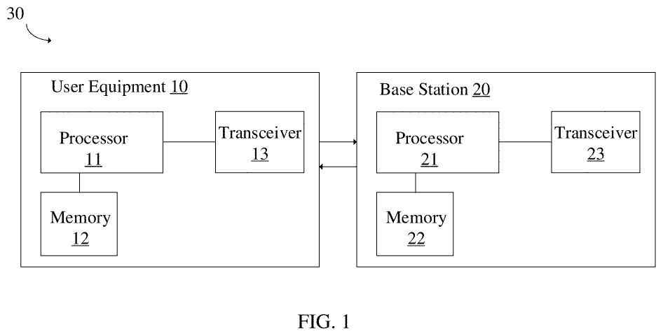

FIG. 1 illustrates that, in some embodiments, one or more user equipments (UEs) 10 and a base station 20 of controlling sidelink communication in a communication network system 30 according to an embodiment of the present disclosure are provided. The communication network system 30 includes the UE 10 and the base station 20. The UE 10 may include a memory 12, a transceiver 13, and a processor 11 coupled to the memory 12, the transceiver 13. The base station 20 may include a memory 22, a transceiver 23, and a processor 21 coupled to the memory 22, the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) Release 16 and beyond. UEs are communicated with each other directly via a sidelink interface such as a PC5 interface. Some embodiments of the present disclosure relate to sidelink communication technology in 3GPP NR release 16 and beyond.

In some embodiments, the processor 21 is configured to use a downlink control information (DCI) format structure to provide at least one sidelink scheduling comprising at least one new radio (NR) scheduling function. The transceiver 23 is configured to provide, to one or more user equipments (UEs) 10, at least one sidelink scheduling according to the DCI format structure. This can save UE processing complexity, power consumption, and control signalling overhead in a new radio (NR) downlink.

In some embodiments, the transceiver 13 is configured to receive, from the base station 10, at least one sidelink scheduling according to a downlink control information (DCI) format structure comprising at least one new radio (NR) scheduling function. The processor 11 is configured to decode the at least one sidelink scheduling of the DCI format structure. This can save UE processing complexity, power consumption, and control signalling overhead in a new radio (NR) downlink.

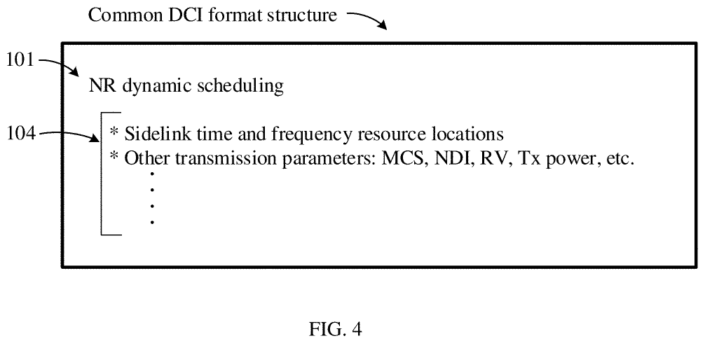

In some embodiments, the DCI format structure may be a common DCI format structure as illustrated in FIG. 4 to FIG. 7. FIG. 4 is an exemplary illustration of a downlink control information (DCI) format structure according to an embodiment of the present disclosure. FIG. 1 and FIG. 4 illustrate that, in some embodiments, the at least one NR SL scheduling function comprises a NR SL dynamic scheduling function 101, the processer 21 is configured to use the NR SL dynamic scheduling function to assign one or more sidelink resources for the one or more UEs 10. In some embodiments, when the processor 21 performs the NR SL dynamic scheduling function 101 for the one or more UEs 10, at least one parameter field 104 of the NR SL dynamic scheduling function 101 is included and encoded as DCI. In some embodiments, the at least one parameter field 104 of the NR SL dynamic scheduling function 101 comprises at least one of the followings: a time location for the one or more sidelink resources; a frequency location for the one or more sidelink resources; or at least one transmission parameter comprising at least one of a new data indicator (NDI), a modulation and coding scheme (MCS), a redundancy version (RV), and a transmit (Tx) power.

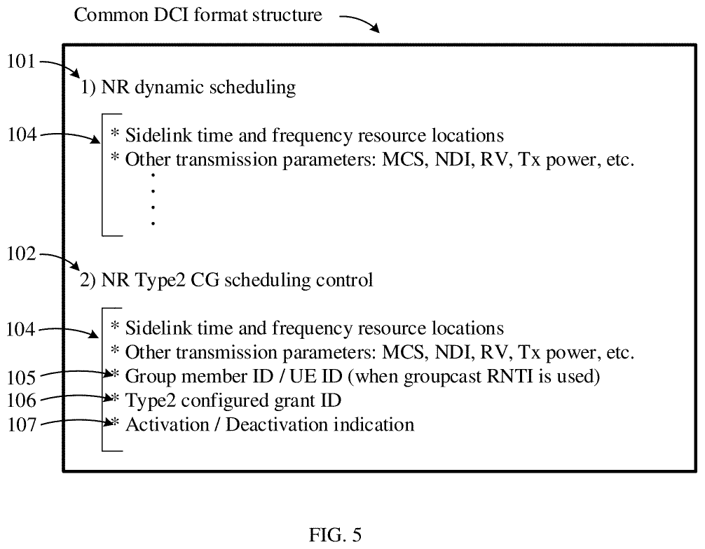

FIG. 5 is an exemplary illustration of a downlink control information (DCI) format structure according to an embodiment of the present disclosure. FIG. 1 and FIG. 4 illustrate that, in some embodiments, the at least one NR SL scheduling function comprises a NR SL dynamic scheduling function 101 and a NR SL Type2 configured grant (CG) scheduling control function 102, the processer 21 is configured to use one of the NR SL dynamic scheduling function 101 and the NR SL Type2 CG scheduling control function 102 to schedule the one or more UEs 10. In some embodiments, when the processor 21 performs one of the NR SL dynamic scheduling function 101 and the NR SL Type2 CG scheduling control function 102, at least one parameter field of one of the NR SL dynamic scheduling function 101 and the NR SL Type2 CG scheduling control function 102 is included and encoded as DCI. In some embodiments, the at least one parameter field 104 of the NR SL dynamic scheduling function 101 comprises at least one of the followings: a time location for the one or more sidelink resources; a frequency location for the one or more sidelink resources; or at least one transmission parameter comprising at least one of a new data indicator (NDI), a modulation and coding scheme (MCS), a redundancy version (RV), and a transmit (Tx) power. In some embodiments, the at least one parameter field 104, 105, 106, 107 of the NR SL Type2 CG scheduling control function 102 comprises at least one of the followings: a time location for the one or more sidelink resources; a frequency location for the one or more sidelink resources; at least one transmission parameter comprising at least one of a new data indicator (NDI), a modulation and coding scheme (MCS), a redundancy version (RV), and a transmit (Tx) power; a group member identity (ID); a UE ID; a SL Type2 CG ID; or an activation and/or deactivation indication.

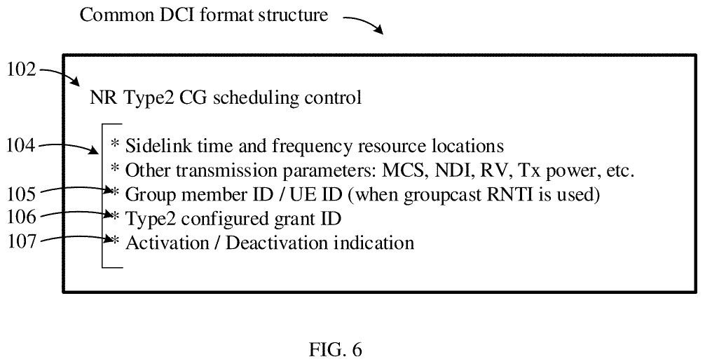

FIG. 6 is an exemplary illustration of a downlink control information (DCI) format structure according to an embodiment of the present disclosure. FIG. 1 and FIG. 6 illustrate that, in some embodiments, the at least one NR SL scheduling function comprises a NR SL Type2 configured grant (CG) scheduling control function 102, the processer 21 is configured to use the NR SL Type2 CG scheduling control function 102 to activate and/or deactivate one or more NR SL Type2 CGs for the one or more UEs 10. In some embodiments, when the processor 21 performs the NR SL Type2 CG scheduling control function 102 for the one or more UEs 10, at least one parameter field 104, 105, 106, 107 of the NR SL Type2 CG scheduling control function 102 is included and encoded as DCI. In some embodiments, the at least one parameter field 104, 105, 106, 107 of the NR SL Type2 CG scheduling control function 102 comprises at least one of the followings: a time location for the one or more sidelink resources; a frequency location for the one or more sidelink resources; at least one transmission parameter comprising at least one of a new data indicator (NDI), a modulation and coding scheme (MCS), a redundancy version (RV), and a transmit (Tx) power; a group member identity (ID); a UE ID; a SL Type2 CG ID; or an activation and/or deactivation indication.

In some embodiments, network configuration of one or more radio network temporary identifier (RNTI) values are provided to the one or more UEs 10 to decode a sidelink scheduling DCI and distinguish between different sidelink scheduling functions in the DCI format structure. In some embodiments, one or more radio network temporary identifier (RNTI) values are used by the processor to perform cyclic redundancy check (CRC) scrambling during channel encoding of DCI. In some embodiments, when the one or more UEs 10 are within a network coverage of the base station 20, one or more RNTI values are configured for the one or more UEs 10 via a UE-specific signalling or a dedicated radio resource control (RRC) signalling. In some embodiments, when the one or more UEs 10 are engaged in a sidelink groupcast session and/or connection, a common groupcast RNTI is configured to the one or more UEs 10 for a groupcast scheduling. In some embodiments, when the UE 10 is engaged in a sidelink groupcast session and/or connection and another one or more UEs are outside of a network coverage of the base station 20, the UE 10 forwards and/or relays sidelink scheduling information received from the base station 20 to the another one or more UEs that are outside of the network coverage of the base station 20.

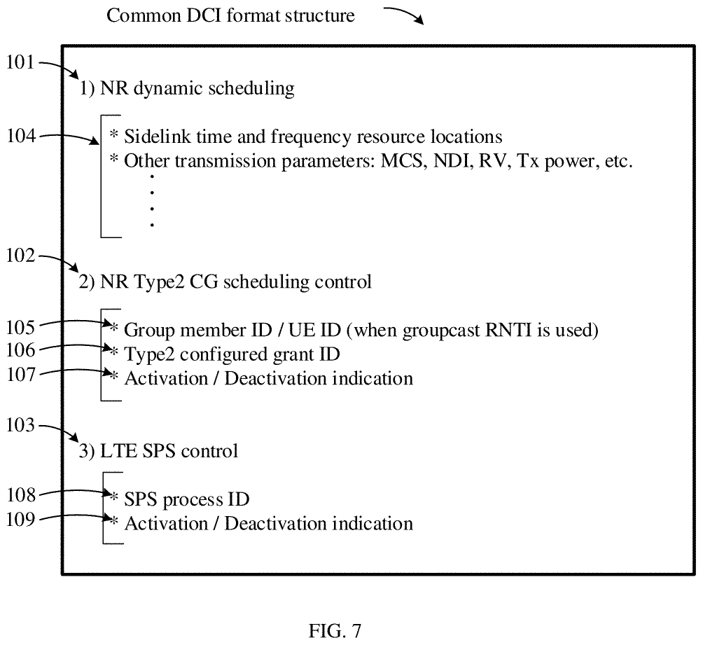

FIG. 7 is an exemplary illustration of a downlink control information (DCI) format structure according to an embodiment of the present disclosure. FIG. 1 and FIG. 7 illustrate that, in some embodiments, at least one sidelink scheduling further comprises a long term evolution (LTE) semi-persistent scheduling (SPS) control function 103, the processer 21 is configured to use the LTE SPS control function 103 to activate and/or deactivate one LTE sidelink SPS process for the one or more UEs 10. In some embodiments, when the processor 21 performs the LTE SPS control function 103 for the one or more UEs, at least one parameter field 108, 109 of the LTE SPS control function 103 is included and encoded as DCI. In some embodiments, the at least one parameter field 108, 109 of the LTE SPS control function103 comprises at least one of the followings: SPS ID; or an activation and/or deactivation indication.

Some embodiments provide several different DCI format structures (for example, DCI format structures as illustrated in FIG. 4 to FIG. 7), therefore, several different DCI format structures can be flexibly provided to a base station as needed. In addition, some embodiments provide a DCI format structure having one or more SL scheduling functions (for example, a function for NR SL dynamic scheduling 101, a function for NR SL Type2 configured grant (CG) scheduling control 102, and/or a function for LTE semi-persistent scheduling (SPS) control 103 as illustrated in FIG. 4 to FIG. 7), therefore, one or more SL scheduling functions can be flexibly provided to the base station as needed.

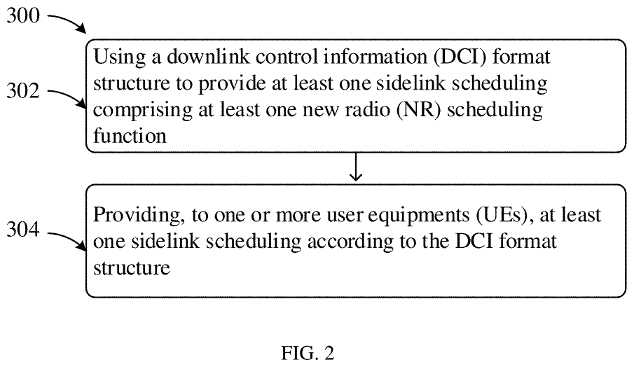

FIG. 2 illustrates a method 300 of controlling sidelink communication of a base station according to an embodiment of the present disclosure. In some embodiments, the method 300 includes: a block 302, using a downlink control information (DCI) format structure to provide at least one sidelink scheduling comprising at least one new radio (NR) scheduling function, and a block 304, providing, to one or more user equipments (UEs), at least one sidelink scheduling according to the DCI format structure. This can save UE processing complexity, power consumption, and control signalling overhead in a new radio (NR) downlink.

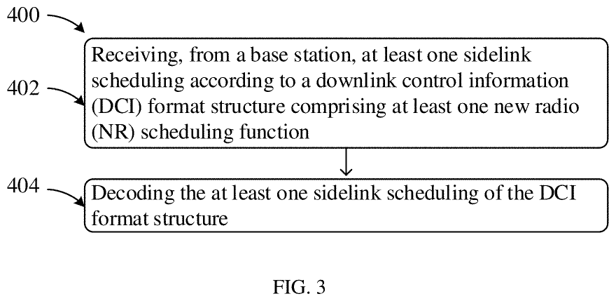

FIG. 3 illustrates a method 400 of controlling sidelink communication of a user equipment (UE) according to an embodiment of the present disclosure. In some embodiments, the method 400 includes: a block 402, receiving, from a base station, at least one sidelink scheduling according to a downlink control information (DCI) format structure comprising at least one new radio (NR) scheduling function, and a block 404, decoding the at least one sidelink scheduling of the DCI format structure. This can save UE processing complexity, power consumption, and control signalling overhead in a new radio (NR) downlink.

In some embodiments, the DCI format structure may be a common DCI format structure. In some embodiments, the at least one NR SL scheduling function comprises a NR SL dynamic scheduling function, the method comprises using the NR SL dynamic scheduling function to assign one or more sidelink resources for the one or more UEs. In some embodiments, when the base station performs the NR SL dynamic scheduling function for the one or more UEs, at least one parameter field of the NR SL dynamic scheduling function is included and encoded as DCI. In some embodiments, the at least one parameter field of the NR SL dynamic scheduling function comprises at least one of the followings: a time location for the one or more sidelink resources; a frequency location for the one or more sidelink resources; or at least one transmission parameter comprising at least one of a new data indicator (NDI), a modulation and coding scheme (MCS), a redundancy version (RV), and a transmit (Tx) power.

In some embodiments, the at least one NR SL scheduling function comprises a NR SL Type2 configured grant (CG) scheduling control function, the base station is configured to use the NR SL Type2 CG scheduling control function to activate and/or deactivate one or more NR SL Type2 CGs for the one or more UEs. In some embodiments, when the base station performs the NR SL Type2 CG scheduling control function for the one or more UEs, at least one parameter field of the NR SL Type2 CG scheduling control function is included and encoded as DCI. In some embodiments, the at least one parameter field of the NR SL Type2 CG scheduling control function comprises at least one of the followings: a time location for the one or more sidelink resources; a frequency location for the one or more sidelink resources; at least one transmission parameter comprising at least one of a new data indicator (NDI), a modulation and coding scheme (MCS), a redundancy version (RV), and a transmit (Tx) power; a group member identity (ID); a UE ID; a SL Type2 CG ID; or an activation and/or deactivation indication.

In some embodiments, the at least one NR SL scheduling function comprises a NR SL dynamic scheduling function and a NR SL Type2 configured grant (CG) scheduling control function, the base station is configured to use one of the NR SL dynamic scheduling function and the NR SL Type2 CG scheduling control function to schedule the one or more UEs. In some embodiments, when the base station performs one of the NR SL dynamic scheduling function and the NR SL Type2 CG scheduling control function, at least one parameter field of one of the NR SL dynamic scheduling function and the NR SL Type2 CG scheduling control function is included and encoded as DCI. In some embodiments, the at least one parameter field of the NR SL dynamic scheduling function comprises at least one of the followings: a time location for the one or more sidelink resources; a frequency location for the one or more sidelink resources; or at least one transmission parameter comprising at least one of a new data indicator (NDI), a modulation and coding scheme (MCS), a redundancy version (RV), and a transmit (Tx) power. In some embodiments, the at least one parameter field of the NR SL Type2 CG scheduling control function comprises at least one of the followings: a time location for the one or more sidelink resources; a frequency location for the one or more sidelink resources; at least one transmission parameter comprising at least one of a new data indicator (NDI), a modulation and coding scheme (MCS), a redundancy version (RV), and a transmit (Tx) power; a group member identity (ID); a UE ID; a SL Type2 CG ID; or an activation and/or deactivation indication.

In some embodiments, network configuration of one or more radio network temporary identifier (RNTI) values are provided to the one or more UEs to decode a sidelink scheduling DCI and distinguish between different sidelink scheduling functions in the DCI format structure. In some embodiments, one or more radio network temporary identifier (RNTI) values are used by the base station to perform cyclic redundancy check (CRC) scrambling during channel encoding of DCI. In some embodiments, when the one or more UEs are within a network coverage of the base station, one or more RNTI values are configured for the one or more UEs via a UE-specific signalling or a dedicated radio resource control (RRC) signalling. In some embodiments, when the one or more UEs are engaged in a sidelink groupcast session and/or connection, a common groupcast RNTI is configured to the one or more UEs for a groupcast scheduling. In some embodiments, when the UE is engaged in a sidelink groupcast session and/or connection and another one or more UEs are outside of a network coverage of the base station, the UE forwards and/or relays sidelink scheduling information received from the base station to the another one or more UEs that are outside of the network coverage of the base station.

In some embodiments, at least one sidelink scheduling comprises a long term evolution (LTE) semi-persistent scheduling (SPS) control function, the base station is configured to use the LTE SPS control function to activate and/or deactivate one LTE sidelink SPS process for the one or more UEs. In some embodiments, when the base station performs the LTE SPS control function for the one or more UEs, at least one parameter field of the LTE SPS control function is included and encoded as DCI. In some embodiments, the at least one parameter field of the LTE SPS control function comprises at least one of the followings: SPS ID; or an activation and/or deactivation indication.

In some embodiments of the present disclosure of the proposed inventive method and apparatus of utilizing a common downlink control information (DCI) format design that can be used for 5th generation—new radio (5G-NR) sidelink (SL) cross-mode scheduling and/or 4th generation—long term evolution (4G-LTE) SL cross-radio access technology (cross-RAT) scheduling, the said common DCI format is to be used with its attached CRC being scrambled by different RNTI values for different modes of SL scheduling, different SL RAT scheduling or different SL operating scenario (e.g. unicast and groupcast).

In reference to FIG. 7, an exemplary structure design for a proposed common DCI format is illustrated with three main SL scheduling functions, namely a function for NR SL dynamic scheduling 101, a function for NR SL Type2 configured grant (CG) scheduling control 102, and a function for LTE semi-persistent scheduling (SPS) control 103. When the common DCI format is used for one of these scheduling functions and scrambled by an appropriate RNTI value, the related parameter fields are included and encoded as the DCI and transmitted to the UE over NR downlink (DL). That is, when the network gNB performs NR SL dynamic scheduling for a UE, only the parameter fields in 104 will be included and encoded. At a receiver UE, it uses one of RNTI values configured by the network gNB to blindly decode the DCI transmitted in physical downlink control channel (PDCCH). If the blind decoding is successful (using the RNTI value corresponds to NR SL dynamic scheduling), the receiver UE extracts SL scheduling information contents according to parameter fields defined in (104). If network gNB performs NR SL Type2 CG scheduling for a UE, it will use the RNTI value that corresponds to SL Type2 CG scheduling configured for that UE to scramble the CRC during DCI encoding and include additionally one or more of the parameter fields 105, 106, and 107. Similar process applies for the scheduling of LTE SPS to a UE. As such, at the beginning, a NR sidelink UE under the network control (i.e. operating in RRC connected mode) is configured by the network with one or more RNTI value(s) for sidelink operations. The network gNB uses one of these configured RNTI value(s) to perform SL scheduling to the UE according to its scheduling function.

For the 1st NR sidelink dynamic scheduling function 101, it can be used by the network gNB to perform scheduling of NR sidelink resources for a UE to transmit only one packet transport block (TB) in a sidelink resource pool. This can include SL resources for retransmissions of the same packet TB. The parameter fields in 104 would typically include time and frequency location for the scheduled SL resources and other transmission parameters such as modulation and coding scheme (MCS), new data indicator (NDI), redundancy version (RV), transmit (Tx) power, and etc.

For the 2nd NR sidelink Type2 CG scheduling control function 102, it can be used by the network gNB to perform controlling of NR SL Type2 CG scheduling for a UE to transmit one or more packet TBs (including retransmissions) in a sidelink resource pool. One or more NR SL Type2 CGs for SL transmission are first configured to a UE. The control of NR SL Type2 CG(s) in the 2nd NR sidelink Type2 CG scheduling control function 102 is mainly to activate or deactivate one or more of the configured SL Type2 CG(s). Therefore, at least the SL Type2 CG ID 106 or the activation/deactivation indication 107 are included as parameter fields for the 2nd NR sidelink Type2 CG scheduling control function 102. If a UE is involved in a SL groupcast communication session, a group member ID or a UE ID 105 is additionally included as part of the parameter fie1d102, and the CRC generation during the DCI channel encoding is scrambled by a groupcast RNTI. Furthermore, the set of parameter fields 105, 106, and 107 could be repeated in the same DCI and used for activating/deactivating SL Type2 CGs for other UEs in the same groupcast session. Alternatively, the set of parameter fields 106 and 107 could be repeated and used for activating/deactivating multiple SL Type2 CGs for the same UE.

For the 3rd LTE SPS control function 103, it can be used by the network gNB to perform cross-RAT controlling of LTE SPS processes for a UE to transmit one or more packet TBs (including retransmissions) in a sidelink resource pool. Same as the 2nd NR SL Type2 CG scheduling control function 102, the said 3rd LTE SPS control function 103 includes similar parameter fields such as SPS process ID 108 and activation/deactivation indication 109. Since the operation of sidelink SPS in LTE does not support groupcast and unicast communications, the design of this 3rd control function does not need to include an ID to identify the intended UE. As such, the RNTI value for CRC scrambling when the 3rd LTE SPS control function 103 is sent in the DCI should be UE-specific/dedicated RRC configured to the UE.

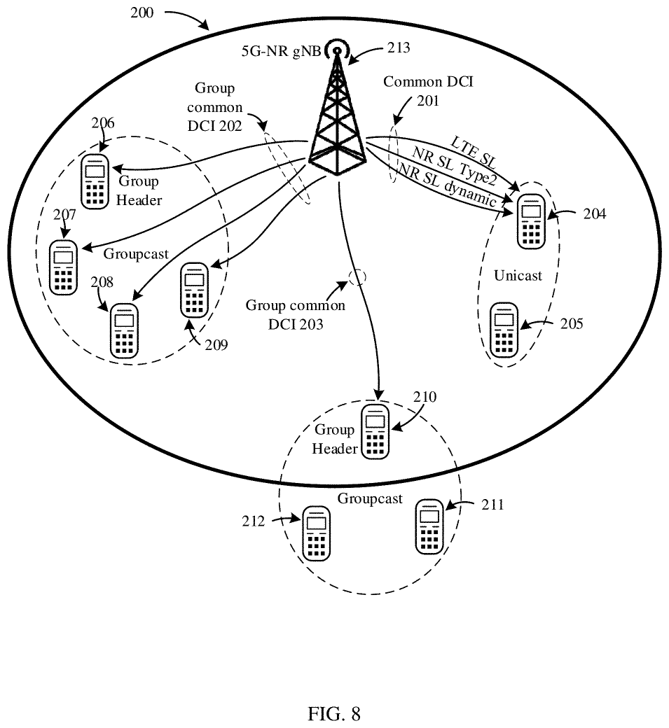

In reference to diagram 200 in FIG. 8, an exemplary illustration of a proposed common DCI format structure can be used in different SL operating scenarios. In a NR SL operating scenario of a unicast communication session between UEs 204 and 205, the UE 204 may be simultaneously engaging in multiple vehicle-to-everything (V2X) services across NR and LTE RATs. For the LTE SL, the UE 204 needs to periodically broadcast/transmit its basic road safety messages such as vehicle status. For the NR SL, it may be engaged in multiple services at the same time such as autonomous driving where the said UE 204 needs to broadcast driving intention messages for a lane change and having a unicast session with UE 205 for an infotainment service. For each one of these services, the 5G-NR gNB 213 needs to provide scheduling of SL resources for transmitting its required data packets. In this instance, the common DCI 201 could be used to provide scheduling for all of these transmissions. When the said common DCI 201 is used for LTE SL scheduling, the NR gNB 213 uses the 3rd LTE SPS control function 103 to activate one of LTE SPS processes for transmitting its basic road safety messages. When the said common DCI 201 is used for scheduling NR SL transmissions to broadcast its driving intention messages, the NR gNB 213 uses the 1st NR sidelink scheduling function 101 to allocate necessary resources and set other transmission parameters for the UE 204. When the said common DCI 201 is used for scheduling NR SL unicast transmissions, the NR gNB 213 uses the 2nd NR SL Type2 CG scheduling control function 102 to activate/deactivate one or more of NR SL Type2 CGs for UE 204.

In another NR SL operating scenario of a groupcast communication session between UEs 206, 207, 208 and 209, where all UEs of the said groupcast session are within the network coverage, all having a RRC connection with the NR gNB 213, and UE 206 is the group header for the said groupcast session. In this NR sidelink operating scenario, the said NR gNB 213 configures a groupcast RNTI value to all group member UEs and sends only one group common DCI 202 for scheduling NR SL resources for all group member UEs to reduce control signalling overhead in the DL. The group common DCI 202, which is a DCI that is common to the whole group, may have the same common DCI structure as in at least one of FIG. 2 to FIG. 7. When the group common DCI 202 is used to provide NR SL scheduling for multiple UEs within the same group, the NR gNB uses the 2nd NR sidelink Type2 CG scheduling control function 102 to activate and/or deactivate NR SL Type2 CGs for the UEs. Since the group common DCI 202 CRC attachment will be scrambled by the same groupcast RNTI that is already configured to all UEs, all group member UEs would receive the same group common DCI contents and obtain same knowledge about each other's scheduling information. As such, each UE knows the transmission timing of every other UEs within the group and be able to shut-down/turn off radio frequency (RF) receiver circuitries and baseband processors during the time when no UE is transmitting to save power.

In another NR SL operating scenario of a groupcast communication session between UEs 210, 211 and 212, where only UE 210 is within the network coverage having a RRC connection with the NR gNB 213, UE 211 and 212 are outside of network coverage, and UE 210 has been assigned as the group header for the groupcast communication session. In this NR sidelink operating scenario, the said NR gNB 213 configures a groupcast RNTI value to the group header UE 210 and sends a group common DCI 203 in the NR downlink intended for the group header UE 210 with its CRC scrambled by the configured groupcast RNTI. Although not all group member UEs are within the network coverage, in order for the NR gNB 203 to provide NR SL scheduling resources to all group members, the said NR gNB 203 again uses the 2nd NR sidelink Type2 CG scheduling control function 102 to activate and/or deactivate multiple NR SL Type2 CGs for the group of UEs. Since the 2nd NR SL Type2 CG scheduling control function includes a group member ID parameter field 105, the group header UE 210 will be able to identify and forward/relay the SL Type2 CG IDs 106 and activation/deactivation indications 107 to the intended group member UE via PC5 RRC signalling.

Overall, in some embodiments, based on the above description of the proposed inventive method and apparatus of using a common DCI format design combined with the assignment/configuration of RNTI values for cross-RAT and/or cross-mode (NR SL dynamic or SL Type2 CG) scheduling, it is able to provide network controlled scheduling for various SL operating scenarios and use cases spanning across all broadcast, unicast and groupcast communication, within or even outside the network coverage.

In summary, in some embodiments, a common DCI format structure that can be used by a network gNB to provide cross-RAT and/or multi-mode sidelink scheduling functions to one or more UEs at the same time to save UE processing complexity, power consumption, and control signalling overhead in the NR downlink. The common DCI format structure can provide two or more of the following scheduling functions. 1. The NR SL dynamic scheduling function can be used by the gNB to assign NR SL resources for a UE to transmit just one or multiple packet TBs (including retransmissions). 2. The NR SL Type2 configured grant scheduling control function can be used by the gNB to activate/deactivate one or more NR SL Type2 CGs for a UE or a group of UEs. 3. The LTE semi-persistent scheduling control function can be used by the gNB to activate/deactivate one LTE SL SPS process for a UE to transmit more than one packet TBs. In some embodiments, network configuration of one or multiple RNTI values that can be used by the UE to decode a common SL scheduling DCI and distinguish between different sidelink scheduling functions within the common DCI format structure. One of the configured RNTI value(s) is used by the network gNB to perform CRC scrambling during the channel encoding of a DCI. When the UE is within the network coverage, the one or multiple RNTI values are configured for the UE via UE-specific/dedicated RRC signalling. When the UE is engaged in a SL groupcast session/connection, a common groupcast RNTI is configured to the UE for the groupcast scheduling. When the UE is engaged in a SL groupcast session/connection and one or more group member UEs are outside of network coverage, the UE forwards/relays SL scheduling information received from the network gNB to group member UEs that are out-of-coverage.

Commercial interests for some embodiments are as follows. 1. Solving issues in the prior art. 2. Saving UE processing complexity, power consumption, and control signalling overhead in a new radio (NR) downlink. 3. Providing good communication performance. 4. Providing high reliability. 5. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product.

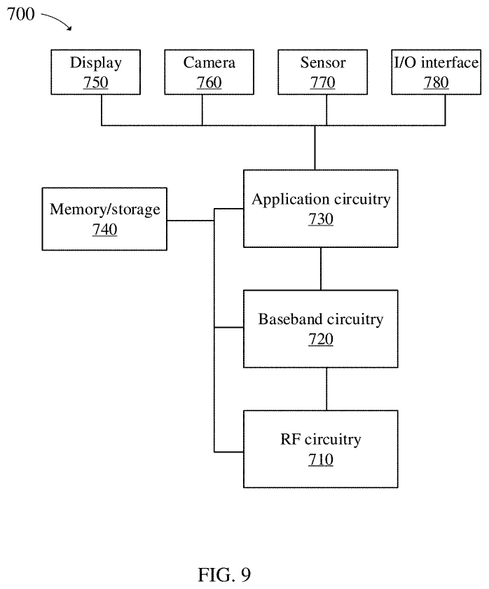

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A base station for sidelink communication, comprising:
a memory;
a transceiver; and
a processor coupled to the memory and the transceiver;
wherein the processor is configured to use a downlink control information (DCI) format structure to provide at least one sidelink (SL) scheduling comprising at least one new radio (NR) SL scheduling function; and
wherein the transceiver is configured to provide, to one or more user equipments (UEs), at least one sidelink scheduling according to the DCI format structure.

2. The base station of claim 1, wherein the at least one NR SL scheduling function comprises at least one of a NR SL dynamic scheduling function or a NR SL Type2 configured grant (CG) scheduling control function, the processer is configured to use one of the NR SL dynamic scheduling function and the NR SL Type2 CG scheduling control function to schedule the one or more UEs.

3. A user equipment (UE) for sidelink communication, comprising:
a memory;
a transceiver; and
a processor coupled to the memory and the transceiver;
wherein the transceiver is configured to receive, from a base station, at least one sidelink (SL) scheduling according to a downlink control information (DCI) format structure comprising at least one new radio (NR) SL scheduling function; and
wherein the processor is configured to decode the at least one sidelink scheduling of the DCI format structure.

4. The UE of claim 3, wherein the at least one NR SL scheduling function comprises at least one of: a NR SL dynamic scheduling function or a NR SL Type2 configured grant (CG) scheduling control function, one of the NR SL dynamic scheduling function and the NR SL Type2 CG scheduling control function is used to schedule the UE or more UEs.

5. The UE of claim 4, wherein when one of the NR SL dynamic scheduling function and the NR SL Type2 CG scheduling control function is performed, at least one parameter field of one of the NR SL dynamic scheduling function and the NR SL Type2 CG scheduling control function is included and encoded as DCI.

6. The UE of claim 5, wherein the at least one parameter field of the NR SL dynamic scheduling function comprises at least one of the followings: a time location for the one or more sidelink resources; a frequency location for the one or more sidelink resources; a new data indicator (NDI), a modulation and coding scheme (MCS), a redundancy version (RV), or a transmit (Tx) power;
wherein the at least one parameter field of the NR SL Type2 CG scheduling control function comprises at least one of the followings: a time location for the one or more sidelink resources; a frequency location for the one or more sidelink resources;
a new data indicator (NDI), a modulation and coding scheme (MCS), a redundancy version (RV), and a transmit (Tx) power; a group member identity (ID); a UE ID; a SL Type2 CG ID; or an activation or deactivation indication.

7. The UE of claim 3, wherein network configuration of one or more radio network temporary identifier (RNTI) values are provided to the UE or more UEs to decode a sidelink scheduling DCI and distinguish between different sidelink scheduling functions in the DCI format structure.

8. The UE of claim 3, wherein one or more radio network temporary identifier (RNTI) values are used to perform cyclic redundancy check (CRC) scrambling during channel encoding of DCI.

9. The UE of claim 3, wherein when the UE or more UEs are within a network coverage of the base station, one or more RNTI values are configured for the UE or more UEs via a UE-specific signalling or a dedicated radio resource control (RRC) signalling.

10. The UE of claim 3, wherein when the UE or more UEs are engaged in a sidelink groupcast session and/or connection, a common groupcast RNTI is configured to the UE or more UEs for a groupcast scheduling.

11. The UE of claim 3, wherein when the UE is engaged in a sidelink groupcast session and/or connection and another one or more UEs are outside of a network coverage of the base station, the UE forwards and/or relays sidelink scheduling information received from the base station to the another one or more UEs that are outside of the network coverage of the base station.

12. A method for sidelink communication of a user equipment (UE), comprising:
receiving, from a base station, at least one sidelink (SL) scheduling according to a downlink control information (DCI) format structure comprising at least one new radio (NR) SL scheduling function; and
decoding the at least one sidelink scheduling of the DCI format structure.

13. The method of claim 12, wherein the at least one NR SL scheduling function comprises at least one of a NR SL dynamic scheduling function or a NR SL Type2 configured grant (CG) scheduling control function, one of the NR SL dynamic scheduling function and the NR SL Type2 CG scheduling control function is used to schedule the UE or more UEs.

14. The method of claim 13, wherein when one of the NR SL dynamic scheduling function and the NR SL Type2 CG scheduling control function is performed, at least one parameter field of one of the NR SL dynamic scheduling function and the NR SL Type2 CG scheduling control function is included and encoded as DCI.

15. The method of claim 14, wherein the at least one parameter field of the NR SL dynamic scheduling function comprises at least one of the followings: a time location for the one or more sidelink resources; a frequency location for the one or more sidelink resources; a new data indicator (NDI), a modulation and coding scheme (MCS), a redundancy version (RV), or a transmit (Tx) power;
wherein the at least one parameter field of the NR SL Type2 CG scheduling control function comprises at least one of the followings: a time location for the one or more sidelink resources; a frequency location for the one or more sidelink resources;
a new data indicator (NDI), a modulation and coding scheme (MCS), a redundancy version (RV), and a transmit (Tx) power; a group member identity (ID); a UE ID; a SL Type2 CG ID; or an activation or deactivation indication.

16. The method of claim 12, wherein network configuration of one or more radio network temporary identifier (RNTI) values are provided to the UE or more UEs to decode a sidelink scheduling DCI and distinguish between different sidelink scheduling functions in the DCI format structure.

17. The method of claim 12, wherein one or more radio network temporary identifier (RNTI) values are used to perform cyclic redundancy check (CRC) scrambling during channel encoding of DCI.

18. The method of claim 12, wherein when the UE or more UEs are within a network coverage of the base station, one or more RNTI values are configured for the UE or more UEs via a UE-specific signalling or a dedicated radio resource control (RRC) signalling.

19. The method of claim 12, wherein when the UE or more UEs are engaged in a sidelink groupcast session and/or connection, a common groupcast RNTI is configured to the UE or more UEs for a groupcast scheduling.

20. The method of claim 12, wherein when the UE is engaged in a sidelink groupcast session and/or connection and another one or more UEs are outside of a network coverage of the base station, the UE forwards and/or relays sidelink scheduling information received from the base station to the another one or more UEs that are outside of the network coverage of the base station.
